(19) United States
(12) Patent Application Publication
(10) Pub. No.: US 2023/0303344 A1
(43) Pub. Date: Sep. 28, 2023

(54) SYSTEMS FOR LOADING AND UNLOADING MOVABLE STOCK-PICKING HOLDERS ON A AUTONOMOUS MOBILE ROBOT FOR ORDER PICKING

(71) Applicant: IFOLLOW, MEUDON (FR)

(72) Inventors: Vincent Jacquemart, MEUDON (FR); Nicolas Menigoz, PARIS (FR)

(21) Appl. No.: 18/004,766

(22) PCT Filed: Jul. 8, 2021
(86) PCT No.: PCT/EP2021/068943

§ 371 Date: Jan. 9, 2023

(30) Foreign Application Priority Data
Jul. 10, 2020 (FR) FR2007365

(51) Int. Cl. B65G 65/00; B65G 1/137; B66F 9/06

(52) U.S. Cl. CPC B65G 65/00; B65G 1/1373; B66F 9/063

(57) ABSTRACT

A loading system for loading at least two movable stock-picking holders, referred to as picking holders, onto a mobile autonomous robot for order-picking of products stored in a warehouse. The loading system includes: a positioning device for positioning the at least two picking holders at a predetermined distance above the ground and a depositing device for depositing the at least two picking holders onto the mobile autonomous robot. Also provided is an unloading system.

### FIELD OF THE INVENTION

The field of the invention is that of logistics, in particular for picking orders in a warehouse storing products to be dispatched.

The present invention relates in particular to assistance for picking orders by means of autonomous mobile robots (AMRs), and more particularly the picking abilities of such autonomous robots for optimising the picking of orders, including for loading and unloading these robots.

### PRIOR ART

The logistics field has been continuously evolving for many years. With regard to preparing orders in particular, the technical and technological developments have been numerous, ranging from management software to product conveyors through smart storage racks.

The concern here is more particularly with the preparation of orders implemented by operators and assisted by autonomous robots. Thus the operators and the robots cooperate in the same work space in order to prepare, in an optimum manner, the various orders that are received by the order management system of the warehouse.

Conventionally, an operator is responsible for picking the various products of an order at the various locations in the warehouse and depositing them on the autonomous robot accompanying him. More precisely, such robots adapted for order picking are equipped with carriages or picking holders, usually having several shelves for depositing products picked by the operators.

However, the field of order picking is a very competitive field that is continuously seeking solutions for improving the efficiency of order picking, in particular by reducing the movements of the operators and of the autonomous mobile robots, as well as optimising each of the steps in the logistics chain.

It therefore exists a need for providing a novel approach that can adapt in real time to the various constraints of order picking while optimising the overall efficiency of the system, i.e. the efficiency of the operators and of the robots, but also the phases prior (preparation of the robots) and subsequent (finalisation of the orders) to the order picking proper.

### SUMMARY OF THE INVENTION

The present invention proposes a technical solution for optimising the overall efficiency of the preparation system by means of a system for loading at least two movable stock-picking holders, referred to as picking holders, on an autonomous mobile robot adapted for picking orders for products stored in a warehouse, the loading system comprising:
a device for positioning the at least two picking holders at a predetermined distance above the floor;
a device for depositing the at least two picking holders on the autonomous mobile robot.

Thus the present technique proposes a novel and inventive solution for picking orders implemented by autonomous mobile robots in a warehouse, making it possible to greatly increase the productivity of the order picking. To do this, the autonomous mobile robots are adapted to the picking of orders for products stored in a warehouse, i.e. they have specific characteristics such as, in particular:
abilities to communicate with other robots in the same fleet and with a supervision system responsible for managing a fleet of robots, for the purpose of optimising stock picking in a warehouse;
ease of movement in warehouse aisles, in which other robots travel, as well as order pickers;
endurance for being able to pick the greatest number of orders without having to be recharged;
compactness and in particular thinness, for example to be able to slide under elements to be transported.

In addition, according to the present technique, such autonomous mobile robots are designed to be able to carry and therefore move at least two stock-picking holders, thus making it possible for example to pick two separate orders directly in two separate containers.

Finally, the loading (and unloading) of the stock-picking holders is fully integrated in the order-picking logistic chain by virtue of a specific system.

The main advantage of this solution lies in the possibility of using a plurality of stock-picking holders on a single autonomous mobile robot and being able to use these same stock-picking holders for transporting products collected directly at the end of order picking.

To do this, the system proposed comprises:
a device for positioning the stock-picking holders at a predetermined distance above the ground, so that an autonomous mobile robot can position itself underneath to receive them;
a device for depositing, on the autonomous mobile robot, stock-picking holders previously positioned for the order picking.

According to a particular aspect, the positioning and depositing devices comprise respective independent positioning and depositing means for each of the at least two picking holders.

Thus, according to this embodiment, the picking holders can be loaded independently on an autonomous mobile robot. This makes it possible for example to load a first stock-picking holder on an autonomous mobile robot in order to start an order picking and then, during the travel thereof in the warehouse, to load a second stock-picking holder (for example to start the picking of a second order). Ditto for the independent unloading (described below) of two order holders for example with two lorry-loading locations for transporting two separate orders.

For example, the positioning device comprises a device for lifting the picking holders and a device for conveying the picking holders as far as said lifting device.

Thus, according to this embodiment, the picking holders are first conveyed, by a specific conveying device of the proposed system, to the lifting device so as to be loaded onto a autonomous mobile robot. This conveying device can be fully automated and further reinforce the productivity and self-contained nature of the entire order picking chain. It is for example in the form of a slope on which the picking holders can run and at the end of which the lifting device is located.

According to a particular feature, the lifting device is incorporated in the autonomous mobile robot.

Thus, according to this embodiment, the loading system conveys the picking holders to a location above the autonomous mobile robot, which activates its own lifting system to recover the picking holders and thus to be able to move them in complete safety.

According to one embodiment of the proposed technique, the positioning and depositing devices correspond to a single device comprising two parallel walls distant by at least a picking-holder width and each having on their internal face at least two vertical runners in which a vertical movement element of a picking holder slide respectively and independently.

Thus, according to this embodiment, the loading system is in the form of a kind of corridor in which the stock-picking holders are conveyed and the internal walls of which, facing each other, have runners for the sliding of elements for vertical movement (for the positioning and depositing) of the picking holders.

Thus, each internal wall comprises at least two runners for the respective sliding of at least one positioning/depositing element, so as to be able to independently lift two stock-picking holders.

The opposite positioning/depositing elements, on each internal wall, are of course coordinated to move one and the same holder vertically, and the positioning/depositing elements of each picking holder can also be synchronised so as to lift and deposit two picking holders at the same time on an autonomous mobile robot.

This solution therefore makes it possible to lift vertically, automatically, at least two picking holders to allow the positioning of an autonomous mobile robot under the raised holders, before the automatic depositing of the picking holders on the autonomous mobile robot via the same vertical-movement elements sliding in the runners.

For example, the vertical movement elements are in the form of “fingers” sliding under the picking holder to lift it and then place it on the autonomous mobile robot.

According to a particular aspect, the conveying and depositing devices correspond to a single device for conveying the picking holders as far as the lifting device.

Thus, according to this embodiment, the conveying device makes it possible to bring the picking holders as far as the lifting device, which makes it possible to directly load the holders on the robot, without having need of a depositing device. To do this, it suffices that, at the end of the conveying device, the supports position themselves directly above the robot.

This embodiment is particularly suitable in the case where the lifting device is that of the robot itself.

The present technique also relates to a system for unloading at least two movable stock-picking holders, referred to as picking holders, of an autonomous mobile robot for picking orders for products stored in a warehouse, the unloading system comprising:
a device for positioning the at least two picking holders at a predetermined distance above the autonomous mobile robot;
a device for depositing the at least two picking holders on a separate holder of the autonomous mobile robot.

The unloading system has the same advantages as the loading system and makes it possible to greatly increase the efficiency of the entire order-picking logistic chain, by incorporating therein the unloading of the robots at the end of picking.

In particular, the positioning and depositing devices comprise respective independent positioning and depositing means for each of said at least two picking holders, thus making it possible to discharge a robot of its many holders at two separate locations for example.

According to a particular feature, the positioning device comprises a device for lifting the picking supports delivering raised picking supports, and the unloading system comprises a device for conveying the raised picking supports on the separate holder (usually the floor of the warehouse).

According to one embodiment, the lifting device is incorporated in the autonomous mobile robot.

According to another embodiment, the positioning and depositing devices correspond to a single device comprising two parallel walls distant by at least a picking-holder width and each having, on their internal face, at least two vertical runners in which respectively and independently a vertical-movement element of a picking support slides. This embodiment makes it possible to use one and the same system for loading (described above) and unloading.

According to a particular feature, the loading system described previously and/or the unloading system described previously comprise a module for detecting the presence and/or the absence of at least one picking holder on an autonomous mobile robot.

Thus, according to this embodiment, provision is made for detecting when one or more picking holders is deposited on a robot, via for example a capacitive sensor or a weight-monitoring module supported by the robot. This makes it possible to ensure that the holder or holders are indeed loaded on the robot before it begins to move for the order picking.

Likewise, the depositing of one or more holders can be detected, at the moment of unloading of the robot, for example at the end of order picking.

### LIST OF THE FIGURES

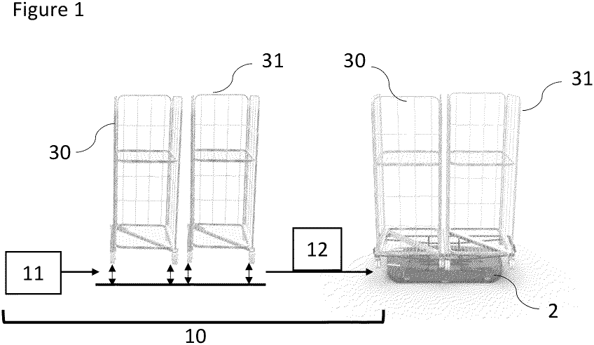

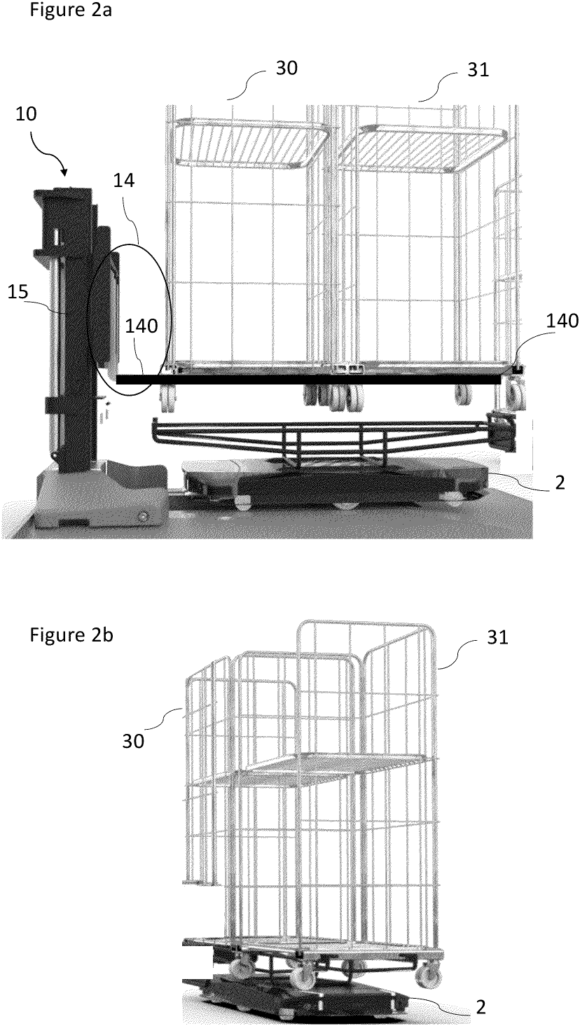

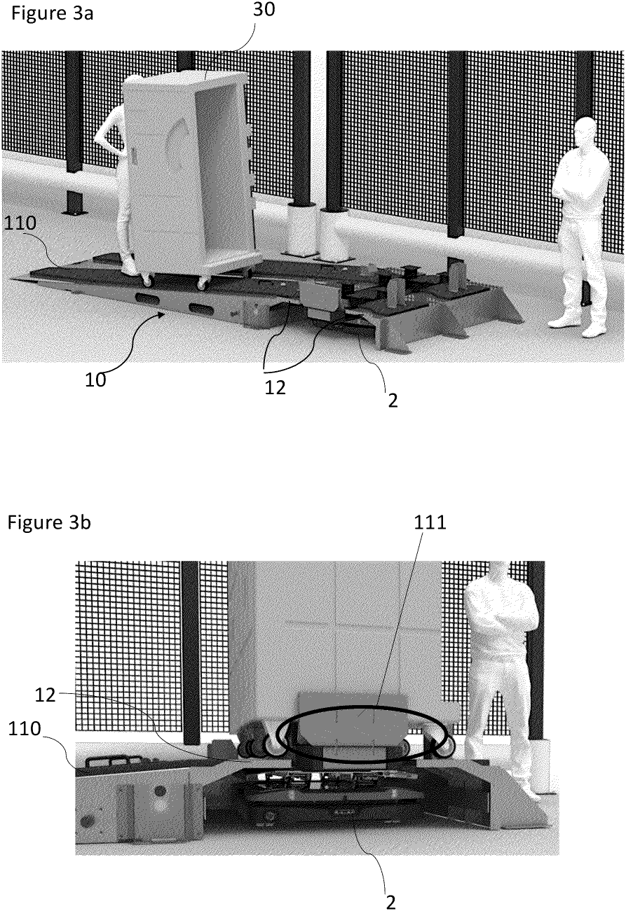

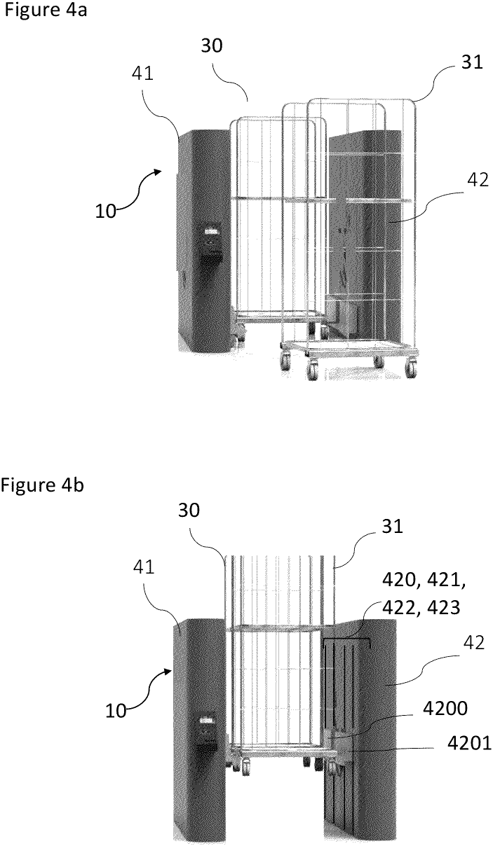

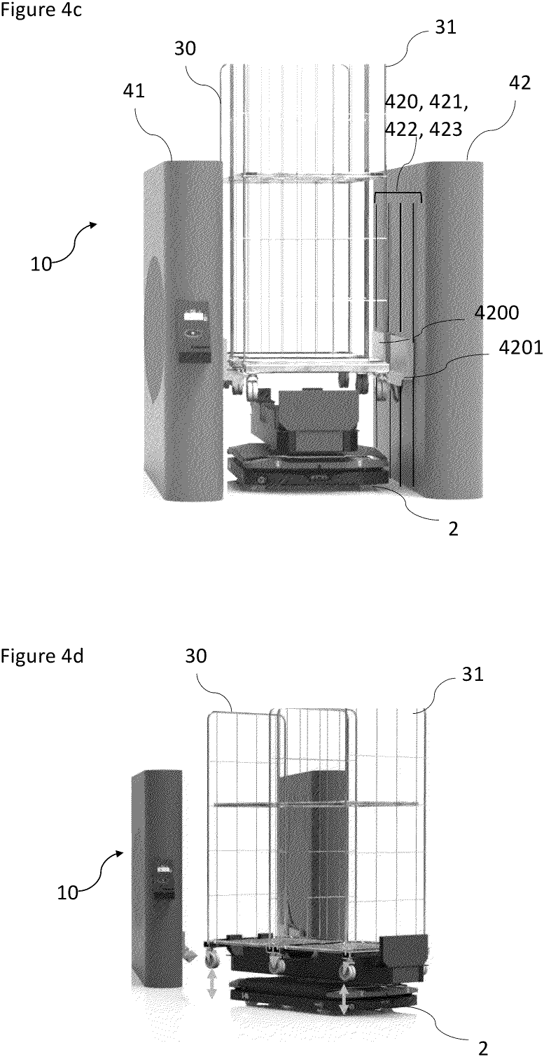

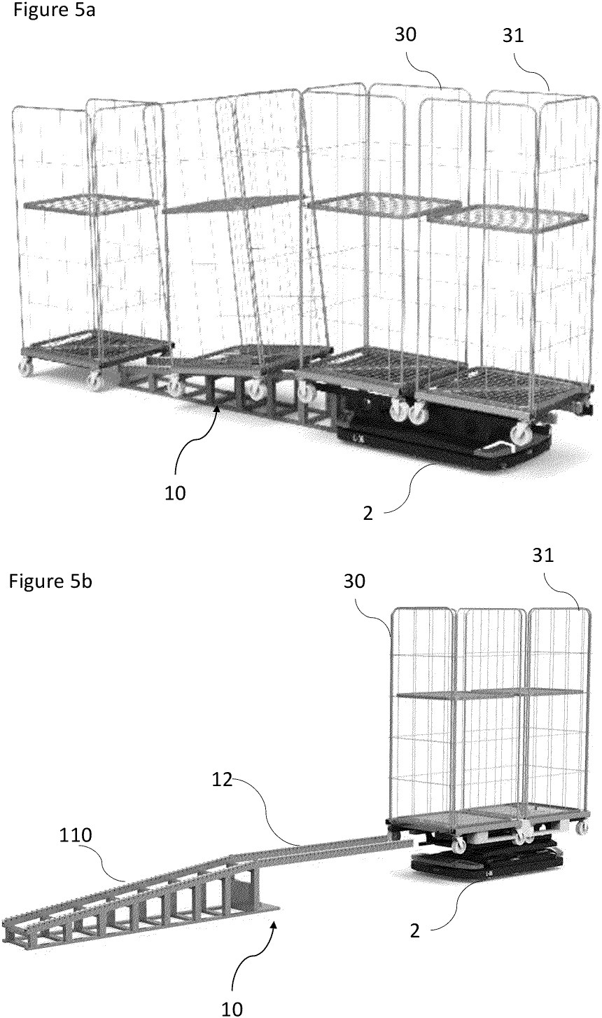

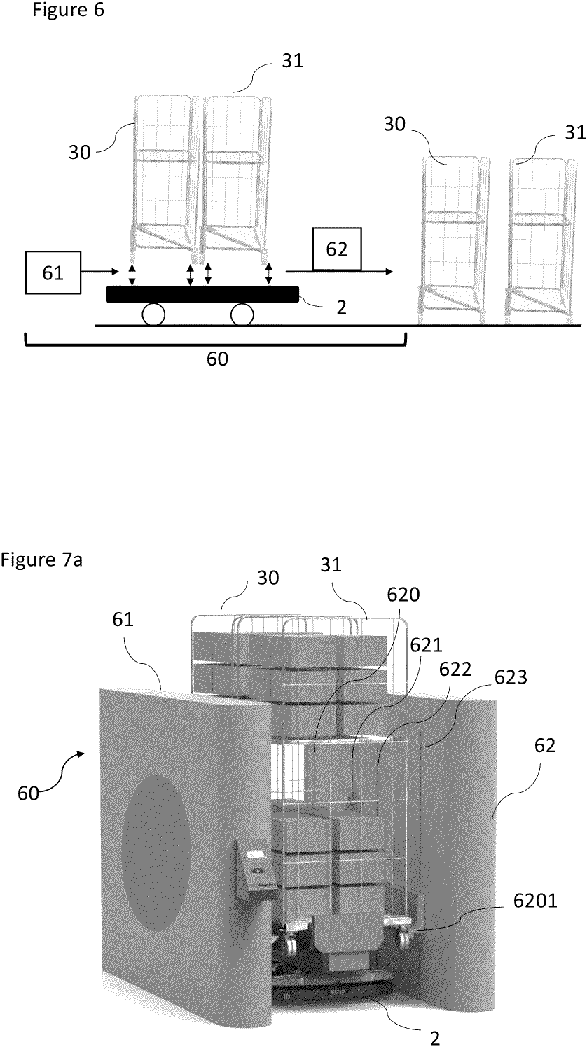

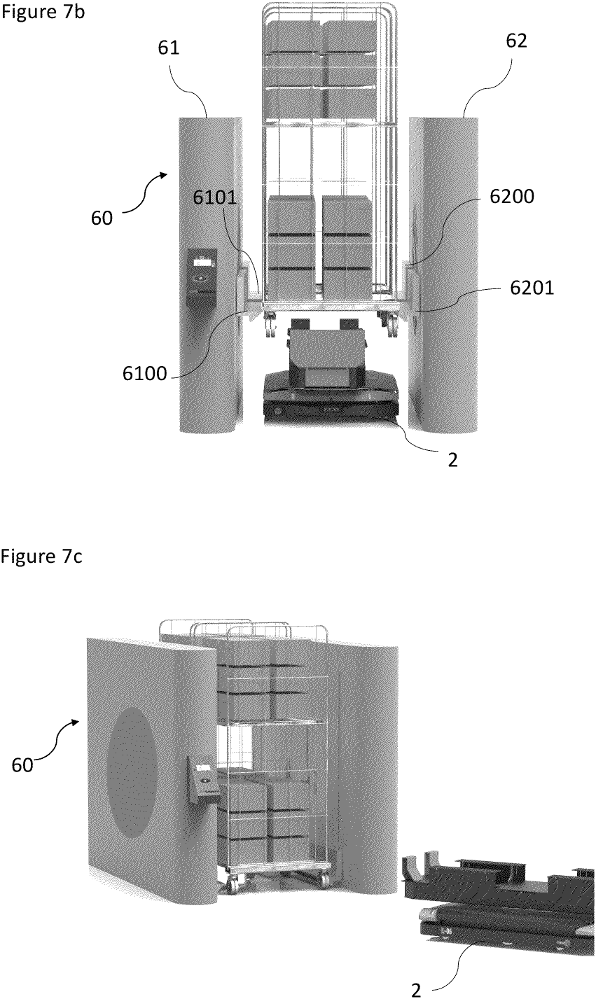

The technique proposed, as well as the various advantages that it presents, will be more easily understood in the light of the following description of several illustrative and non-limitative embodiments thereof, and the accompanying drawings, among which:

[FIG. 1] illustrates a loading system according to the general principle of embodiment of the present technique;

[FIG. 2a] illustrates a loading system according to a first embodiment of the present technique;

[FIG. 2b] illustrates an autonomous mobile robot loaded according to the first embodiment of the present technique;

[FIG. 3a] illustrates a loading system according to a second embodiment of the present technique;

[FIG. 3b] illustrates an autonomous mobile robot loaded according to the second embodiment of the present technique;

[FIG. 4a] illustrates a loading system according to a third embodiment of the present technique, during the positioning of the picking holders;

[FIG. 4b] illustrates a loading system according to the third embodiment of the present technique, when the picking holders are lifted;

[FIG. 4c] illustrates a loading system according to the third embodiment of the present technique, when the picking holders are deposited;

[FIG. 4d] illustrates a autonomous mobile robot loaded according to the third embodiment of the present technique;

[FIG. 5a] illustrates a loading system according to a fourth embodiment of the present technique, during the conveying and lifting of the picking holders;

[FIG. 5b] illustrates a loading system according to the fourth embodiment of the present technique, during the depositing of the picking holders;

[FIG. 6] illustrates an unloading system according to the general principle of embodiment of the present technique, during the positioning of the picking holders;

[FIG. 7a] illustrates an unloading system according to the third embodiment of the present technique, during the positioning of the picking holders;

[FIG. 7b] illustrates an unloading system according to the third embodiment of the present technique, when the picking holders are lifted;

[FIG. 7c] illustrates an unloading system according to the third embodiment of the present technique, when the picking holders are deposited.

### DETAILED DESCRIPTION OF THE INVENTION

### A - General Principle of the Technique Proposed

The general principle of the technique proposed consists in optimising the loading and unloading of a autonomous mobile robot adapted for carrying at least two movable picking holders, as described for example in the patent application FR 2007360 of the same applicant filed on 10 Jul. 2020.

To do this, provision is made for incorporating in the order-picking logistic chain a system for loading and a system for unloading (which may be separate or not) at least two movable picking holders on an autonomous mobile robot.

FIGS. 1 and 6 illustrate respectively the general principle of a system 10 for loading and a system 60 for unloading two movable picking holders 30 and 31, for an autonomous mobile robot 2. The same principles, not illustrated, can apply to three or more movable picking holders, depending on the size of the autonomous mobile robot.

As illustrated in FIG. 1, a loading system 10 according to the technique proposed comprises a device 11 for positioning two picking holders 30, 31 at a predetermined distance above the floor and a device 12 for depositing the two picking holders 30, 31 on the autonomous mobile robot 2. Thus, the idea is that the autonomous mobile robot slides under the previously raised holders in order to receive them (on a reception device as described in particular in the patent application of the same applicant mentioned above) and to move to commence to pick, in the two picking holders, the products taken by one or more order pickers.

Various embodiments of this loading system are described below in relation to FIGS. 2a to 5b.

FIG. 6 for its part illustrates an unloading system 60 according to the technique proposed, comprising a device 61 for positioning the two picking holders 30, 31 at a predetermined distance above the autonomous mobile robot and a device 62 for depositing the two picking holders 30, 31 on a support distinct from the autonomous mobile robot 2, conventionally the floor of the warehouse. Thus, the idea is that the autonomous mobile robot can extract itself from the previously raised holders in order to unload them, when it has finished a picking task.

One embodiment of this unloading system is described below in relation to FIGS. 7a to 7c.

### B - Description of a First Embodiment of the Loading System

FIGS. 2a and 2b illustrate a first embodiment of the loading system 10, wherein the positioning device 11 and the depositing device 12 form a single device 14 for lifting two movable picking holders 30 and 31, and keeping them raised until the autonomous mobile robot 2 places itself underneath, and depositing the two holders on the autonomous mobile robot 2 (for example on the reception device as described in particular in the patent application of the same applicant mentioned above). This loading system 10 is composed of a fixed part 15 and a part 14 able to move vertically in the fixed part (for example via a sliding system in a runner). This part 114 is itself composed of a horizontal part 140 (in black lines on FIG. 2a) able to raise the two movable picking holders. This horizontal part 140 is for example in the form of one or more forks.

Once the two movable picking holders 30 and 31 are positioned above the floor, and then above the autonomous mobile robot 2 that has come to be positioned, the latter extracts itself from the loading zone, with the two movable picking holders 30, 31. The fork or forks 140 can then be lowered and the loading system can once again be used for loading another autonomous mobile robot. FIG. 2b illustrates an autonomous mobile robot 2 loaded with two movable picking holders 30 and 31 (still raised with respect to the floor) and ready to be used for order picking.

According to this first embodiment, the movable picking holders 30 and 31 are brought into the loading zone, above the part 140 (positioned at the suitable height with respect to the configuration of the movable picking holders) by an operator for example or a mobile device dedicated to the conveying of the picking holders to the loading zone or zones, in a warehouse.

It should be noted that this first embodiment of the loading system can be used as an unloading system: at the end of order picking, the autonomous mobile robot 2 places itself in the unloading zone, the part 140 of the device previously having been positioned at the suitable height for being located under the movable picking holders when the autonomous mobile robot positions itself. The part 140 of the unloading device is next actuated to lift the movable picking holders to a sufficient height above the autonomous mobile robot, so that the latter can extract itself, without the movable picking holders, from the unloading zone. The part 140 of the unloading device is next actuated to deposit the movable picking holders on the floor, or any other support (such as for example a device dedicated to conveying the picking holders to a transport lorry).

### C - Description of a Second Embodiment of the Loading System

FIGS. 3a and 3b illustrate a second embodiment of the loading system 10, wherein the positioning device comprising a device 110 for conveying the movable picking holders 30, 31 as far as a device 111 for lifting these picking holders, before they are deposited on the autonomous mobile robot 2.

Thus, according to this second embodiment, the loading system comprises an inclined plane 110 on which the picking holders 30, 31 can be conveyed, with the help of an operator for example (as illustrated in FIG. 3a), as far as a horizontal zone 12 under which the autonomous mobile robot 2 can slide. This zone 12 thus constitutes the depositing device of the loading system, according to this second embodiment, and the lifting device 111 is that of the autonomous mobile robot 2.

Thus, as illustrated in FIG. 3b, once the movable picking holders 30, 31 have been conveyed as far as the depositing device 12, the autonomous mobile robot 2 can actuate its own lifting device 111 to recover the movable picking holders 30, 31, to extract itself from the loading system and to position its lifting device 111 in the suitable configuration for moving the movable picking holders 30, 31 in the context of order picking.

It should be noted that this second embodiment of the loading system can also be used as an unloading system: at the end of order picking, the autonomous mobile robot 2 places itself in the unloading zone 12, after previously having actuated its lifting device 111 so as to raise the movable picking holders so that the latter rest on the part 12 of the unloading system. The movable picking holders are then conveyed via the inclined plane 110 as far as the floor, by an operator for example. The autonomous mobile robot, unloaded, can then move and go for example into another loading zone for a new order, or into a zone for recharging its battery.

### D - Description of a Third Embodiment of the Loading System

FIGS. 4a to 4d illustrate a third embodiment of the loading system 10, wherein the positioning and depositing devices correspond to a single device comprising two parallel walls 41, 42 distant by at least a width of a picking holder, as illustrated on FIG. 4a. The picking holders 30 and 31 are for example positioned between these two walls 41 and 42 by an operator.

As illustrated in FIG. 4c, an autonomous mobile robot 2 can also position itself between these two walls 41 and 42, with a view to unloading thereof by two movable picking holders 30, 31.

Moreover, and as illustrated in FIGS. 4b and 4c, each of the walls 41 and 42 has on its internal face at least two vertical runners (here four runners for the wall 420: 420, 421, 422, 423) in which a vertical movement element (4100, 4101 for the wall 41 and 4200, 4201 for the wall 42) of a picking holder (30, 31) slide respectively and independently.

Thus, according to this third embodiment, the loading system makes it possible to lift, to a predetermined height above the floor, the movable picking holders, independently for one and/or two holders and coordinated for each wall and a picking holder.

For example, if an autonomous mobile robot must be loaded by a single movable picking holder (for example because the robot is already carrying a first movable picking holder), the loading system actuates a single movement element per vertical wall but actuates, in a synchronous/coordinated manner, the two facing elements on each of the walls, i.e. 4100 and 4200 or 4101 and 4201.

On the other hand, to load two movable picking holders, the elements 4100 and 4200 are actuated synchronously to raise the support 30 and the elements 4101 and 4201 are actuated synchronously to raise the holder 31.

The mobility of these vertical movement elements (4100, 4101, 4200, 4201) is therefore provided by the presence of runners in the walls 41 and 42.

As illustrated on FIGS. 4b and 4c, the wall 42 has two runners 420 and 421 for moving the element 4200, and two runners 422 and 423 for moving the element 4201. The wall 41 has the same runners, not illustrated.

According to this embodiment, the elements 4100, 4101 for the wall 41 and 4200, 4201 for the wall 42 have an L shape, a part of which slides in the runners and the other part, for example in the form of horizontal “fingers”, makes it possible to raise the movable picking holders. In this way, a movable picking holder is raised at several points, for example by four fingers, facing each other in pairs (two fingers for one vertical movement element on each wall).

FIG. 4b illustrates more particularly the step of lifting the two movable picking supports 30 and 31, before the step of depositing on the autonomous mobile robot 2.

This step of depositing the movable picking holders 30 and 31 is partly illustrated in FIG. 4c, on which an autonomous mobile robot 2 has positioned itself between the two walls 41 and 42 of the loading system. The movable picking holders 30 and 31 are maintained at a predetermined height above the autonomous mobile robot 2, by means of the elements 4100 and 4101 on the wall 41 (not illustrated) and 4200 and 4201 on the wall 42. The following step consists in lowering the elements 4100, 4101, 4200 and 4201 so as to deposit the movable picking holders 30 and 31 on the autonomous mobile robot 2 (for example on the reception device as described in particular in the patent application of the same applicant mentioned above).

Finally, FIG. 4d illustrates the autonomous mobile robot 2 loaded with the movable picking holders 30 and 31 (still raised with respect to the floor) and ready to be used for the order picking.

### E - Description of a Fourth Embodiment of the Loading System

FIGS. 5a and 5b illustrate a fourth embodiment of the loading system 10, wherein the positioning device comprises a device 110 for conveying the movable picking holders 30, 31 as far as an autonomous mobile robot 2.

Thus, according to this fourth embodiment, the loading system 10 comprises an inclined plane 110 (for example consisting of two rails for receiving the wheels of the movable picking holders) on which the picking holders 30, 31 can be conveyed as far as a horizontal plane corresponding to a depositing zone 12 under which the autonomous mobile robot 2 can slide. This zone 12 thus constitutes the depositing device of the loading system 10, according to this fourth embodiment, and the lifting device 110 is that of the autonomous mobile robot 2.

Thus, as illustrated in FIG. 5b, once the movable picking holders 30, 31 have been conveyed as far as the depositing device 12, the autonomous mobile robot 2 can actuate its own lifting device 111 to recover the movable picking holders 30, 31, to extract itself from the loading system and to position its lifting device 111 in the suitable configuration for moving the movable picking holders 30, 31 in the context of order picking.

It should be noted that this fourth embodiment of the loading system can also be used as an unloading system: at the end of order picking, the autonomous mobile robot 2 places itself under the unloading zone 12, after previously having actuated its lifting device 111 so as to raise the (full) movable picking holders so that the latter rest on the part 12 of the unloading system. The movable picking holders are then conveyed, via the inclined plane 110, as far as the floor. The autonomous mobile robot, unloaded, can then move and go for example into another loading zone for a new order, or into a zone for charging its battery.

### F - Description of the Unloading System According to the Third Embodiment of The Loading System

A description is now given, with FIGS. 7a to 7c, of an embodiment of the unloading system 60, corresponding to the third embodiment of the loading system described above (in relation to FIGS. 4a to 4b).

In this embodiment, the positioning and depositing devices correspond to a single device comprising two parallel walls 61, 62 distant by at least a width of a picking holder, as illustrated on FIG. 7a.

At the end of order picking, the autonomous mobile robot 2 positions itself between these two walls 61 and 62, with a view to its unloading of the two movable picking holders 30, 31 on which products have been deposited for order picking (here boxes illustrate these products).

Moreover, and as illustrated in FIG. 7a, each of the walls 61 and 62 has on its internal face at least two vertical runners (here four runners 620, 621, 622, 623 for the wall 62) wherein a vertical movement element (6100, 6101 for the wall 61 and 6200, 6201 for the wall 62, as illustrated on FIG. 7b) of a picking holder (30, 31) slide respectively and independently.

Thus, according to this embodiment, the unloading system 60 makes it possible to lift the movable picking holders 31 and 32 to a predetermined height above the autonomous mobile robot 2, independently for one and/or two holders and coordinated for each wall and a picking holder.

For example, if an autonomous mobile robot 2 must be discharged of a single movable picking holder (for example because the robot is carrying only one movable picking carrier or because it must unload the two movable picking holders at separate locations), the unloading system actuates a single movement element per vertical wall but actuates in a synchronous/coordinated manner the two facing elements on each of the walls, i.e. 6100 and 6200 or 6101 and 6201.

On the other hand, to unload two movable picking holders the elements 6100 and 6200 are actuated synchronously to lift the support 30, and the elements 6101 and 6201 are actuated synchronously to lift the holder 31.

The mobility of these vertical movement elements (6100, 6101, 6200, 6201) is therefore provided by the presence of runners in the walls 61 and 62.

As illustrated on FIG. 7a, the wall 62 has two runners 620 and 621 for moving the element 6200 (illustrated only in FIG. 7b), and two runners 622 and 623 for moving the element 6201. The wall 61 has the same runners, not illustrated.

According to this embodiment, the elements 6100, 6101 for the wall 61 and 6200, 6201 for the wall 62 have an L shape, a part of which slides in the runners and the other part, for example in the form of horizontal “fingers”, makes it possible to raise the movable picking holders. In this way, a movable picking holder is raised at several points, for example by four fingers, facing in pairs (two fingers for a vertical movement element on each wall).

FIG. 7b illustrates more particularly the step of lifting the two movable picking holders 30 and 31 to a predetermined height above the autonomous mobile robot 2, before the step of depositing on the ground for example, once the autonomous mobile robot 2 has departed (FIG. 7c).

This step of depositing movable picking holders 30 and 31 on the floor is illustrated in FIG. 7c, the autonomous mobile robot 2 having extracted itself from the unloading system. The movable picking holders 30 and 31 are now accessible for being for example conveyed to a zone loading a transport lorry, and the autonomous mobile robot 2 is available for another order picking, or for recharging its battery.

### G - Other Features

The various embodiments described above, respectively for the loading and unloading systems for an autonomous mobile robot, thus make it possible to increase the efficiency of the entire order-picking logistic chain, by optimising the phases of loading the empty picking holders on a robot before use thereof for order picking, as well as the phase of unloading a robot at the end of order picking. These embodiments make it possible in particular to limit the handlings of the movable picking holders, for loading them on an autonomous mobile robot or for unloading them.

Since some embodiments can be automated, these loading and unloading phases can therefore be incorporated in the organisation and management of the order picking in a warehouse, further increasing efficiency.

1. A loading system for loading at least two movable stock-picking holders, referred to as picking holders, on an autonomous mobile robot adapted for picking orders for products stored in a warehouse, wherein the system comprises:
a positioning device configured to position the at least two picking holders at a predetermined distance above the floor; and
a depositing device configured to deposit the at least two picking holders on the autonomous mobile robot.

2. The loading system according to claim 1, wherein the positioning and depositing devices comprise respective independent positioning and depositing elements for each of the at least two picking holders.

3. The loading system according to claim 1, wherein said positioning device comprises a lifting device to lift said picking holders and a conveyor device to convey said picking holders as far as said lifting device.

4. The loading system according to claim 1, wherein said lifting device is incorporated in the autonomous mobile robot.

5. The loading system according to claim 1, wherein said positioning and depositing devices correspond to a single device comprising first and second parallel walls separated by at least a width of at least one of the picking holders and each having on their internal face at least two vertical runners in which a vertical movement element of at least one of the picking holders slides respectively and independently.

6. The loading system according to claim 1, wherein said conveying and depositing devices correspond to a single conveyor device to convey said picking holders as far as said lifting device.

7. An unloading system for unloading at least two movable stock-picking holders, referred to as picking holders, of an autonomous mobile robot for picking orders for products stored in a warehouse, wherein the unloading system comprises:
a positioning device configured to position said at least two picking holders at a predetermined distance above said autonomous mobile robot ; and
a depositing device configured to deposit said at least two picking holders on a separate holder of the autonomous mobile robot.

8. The unloading system according to claim 7, wherein said positioning and depositing devices comprise respective independent positioning and depositing elements for each of said at least two picking holders.

9. The unloading system according to claim 7, wherein said positioning device comprises a lifting device to lift said picking holders delivering raised picking holders, and said unloading system comprises a conveyor device to convey said raised picking holders on said separate holder.

10. The unloading system according to claim 9, wherein said lifting device is incorporated in said autonomous mobile robot.

11. The unloading system according to claim 7, wherein said positioning and depositing devices correspond to a single device comprising first and second parallel walls separated by at least a width of at least one of the picking holders and each having, on their internal face, at least two vertical runners in which respectively and independently a vertical-movement element of at least one of the picking holders slides.

12. The unloading system according to claim 7, comprising a detection module configured to detect presence and/or absence of at least one of the picking holders on the autonomous mobile robot.

13. The loading system according to claim 1, comprising a detection module configured to detect presence and/or absence of at least one of the picking holders on the autonomous mobile robot.
